(19) United States
(12) Patent Application Publication
(10) Pub. No.: US 2011/0302185 A1
(43) Pub. Date: Dec. 8, 2011

(54) DATA PUBLICATION AND SUBSCRIPTION SYSTEM

(75) Inventor: Hugues Vincent, Antony (FR)

(73) Assignee: THALES, NEUILLY SUR SEINE (FR)

(21) Appl. No.: 13/139,891

(22) PCT Filed: Dec. 16, 2009
(86) PCT No.: PCT/EP09/67318

§ 371 Date: Jul. 13, 2011

(30) Foreign Application Priority Data
Dec. 16, 2008 (FR) 0807069

(51) Int. Cl. G06F 17/30

(52) U.S. Cl. 707/760; 707/765; 707/E17.112

(57) ABSTRACT

A data publication and subscription system includes one transmitter publishing data and one receiver subscribing to data, the data being described by one or more identifiers, the transmitters and receivers being interconnected via a network. The system includes an ontological knowledge base common to said transmitters and receivers, at least one data transmitter and receiver, each including a semantic module connected to said base and adapted to analyze a semantic request to find all identifiers semantically associated with this request, said transmitter publishing and said receiver subscribing to data via said identifiers found by the semantic module. The system applies notably to the connection of a plurality of different communications devices, each including data publication and subscription services.

The present invention relates to a data publication and subscription system. The invention applies notably to the connection of a plurality of different communications devices, each including data publication and subscription services.

A computer application connected to a network and communicating via publication/subscription mechanisms often groups the data to be exchanged by subjects. A subject is an identifier, for example a common name, which defines a data category according to, for example, a thematic, chronological or other classification. A large number of these existing applications have been developed independently from one another. Also, the subjects involved differ from one application to another, since the classification methods and/or the syntax used to designate a data category are not the same. Consequently, syntactic limits hinder exchanges of data between these applications. In fact, the publication of a datum by a first application under one subject, for example the subject specified by the identifier “bicycles”, will not be consumed by a different application having subscribed to the subject “two-wheeled vehicles”, because, even if from a semantic point of view a “bicycle” is a “two-wheeled vehicle”, the two subjects are different from the syntactic point of view.

Sometimes, the applications also indicate the type of the datum published and/or to be subscribed to, i.e. their format, which can be described by a data type definition document. Again, the document definitions are not necessarily identical here, even if they correspond de facto to the same data type.

The patent application published under reference WO2005/072114 proposes a method for making data producers interoperable with consuming applications. However, this method provides an interface only with a single data-sharing service. It does not allow the computing load which is to be implemented to be distributed for the distribution of data, and requires the single sharing point to be redundant in order to ensure a high availability of the sharing service.

Current communications infrastructures based on data publication and subscription, such as JMS (“Java Message Service”) or DDS (“Data Distribution System”) do not enable the aforementioned interoperability problem to be resolved. They impose a precise, low-level definition of the subjects and types of data exchanged, thus presenting an obstacle to any integration of heterogeneous applications.

One object of the invention is to propose a communications infrastructure enabling heterogeneous publication and subscription applications grouped by subjects to exchange data. For this purpose, the subject-matter of the invention is a data subscription and publication system including at least one transmitter publishing data and one receiver subscribing to data, the data being described by one or more identifiers, the transmitters and receivers being interconnected via a network, said system being characterized in that it comprises an ontological knowledge base common to said transmitters and receivers, at least one data transmitter and receiver, each including a semantic module connected to said base and adapted to analyze a semantic request to produce identifiers semantically compatible with said request, said transmitter publishing and said receiver subscribing to data via said identifiers.

Unlike the systems in the prior art, in which the identifiers constitute a restraint to the decoupling between the transmitters and receivers, the system according to the invention, by decoupling the identifiers, enables more decoupling of the data transmitters and receivers. The system according to the invention enables a better interoperability between the data-consuming applications and data-producing applications.

According to one embodiment of the system according to the invention, the ontological knowledge base defines semantic concepts interlinked by dependency relationships, each of the identifiers likely to be published or subscribed to by a transmitter or a receiver being referenced, via association means, by at least one concept or one concept instance in said base, the semantic module including a classifier adapted to search in said base for all the identifiers semantically compatible with a semantic request.

According to one embodiment of the system according to the invention, the data transmitters and receivers are computer terminals, a data-consuming application and/or data-producing application being executed on each of said terminals, said application of each computer terminal being connected to the semantic module, which is provided with access to the ontological knowledge base via the network.

Association means for referencing the identifiers likely to be published or subscribed to by a transmitter or receiver by at least one concept or one concept instance of the knowledge base may be included by each transmitter and receiver, said means including one or more correspondence files for correspondence between the concepts of said base and said identifiers.

According to one embodiment of the system according to the invention, at least one transmitter and one receiver include a translation module executing a first transformation script for transformation of a datum formatted in a language specific to said transmitter or to said receiver into a datum formatted in a pivot format specific to the knowledge base, the translation module being provided with a second transformation script for transformation of a datum formatted in a pivot format specific to the knowledge base into a datum formatted in a language specific to said transmitter or to said receiver.

The decoupling of the data types thus obtained enables more decoupling of the data transmitters and receivers.

Moreover, the dependency relationships between the concepts of the ontological knowledge base may be specified, for example, in the “Resource Description Framework” language or the “Web Ontology Language”.

The subject-matter of the invention is also a data subscription and publication method in a system including at least one transmitter publishing data and one receiver subscribing to data, the data being described by one or more identifiers, said method including at least one step of publication of one or more data identifiers by a transmitter, and a step of subscription to one or more identifiers by a receiver, said subscription step including at least the following sub-steps:
referencing, by association means, of the identifiers likely to be subscribed to by said receiver to a semantic specification;
a semantic module included in said data receiver receives a semantic request;
the semantic module interrogates an ontological knowledge base common to the receivers and transmitters of said system to find semantic concepts semantically compatible with said request;
the semantic module translates said concepts into identifiers by using association means,
execution of a subscription request for each of said identifiers supplied by the semantic module.

According to an implementation of the data subscription and publication method according to the invention, said publication step includes at least the following sub-steps:
referencing, by association means, of the identifiers likely to be published by said receiver to a semantic specification;
a semantic module included in said data receiver receives a semantic request;
the semantic module interrogates an ontological knowledge base common to the receivers and transmitters of said system to find semantic concepts semantically compatible with said request;
the semantic module translates said concepts into identifiers by using association means,
execution of a publication request for each of said identifiers supplied by the semantic module.

The semantic requests may be formulated in the “Simple Protocol And RDF Query Language”, more simply designated by the acronym SPARQL.

Other characteristics will become evident from a reading of the detailed description given by way of a non-limiting example which follows, provided with reference to the attached drawings, in which:

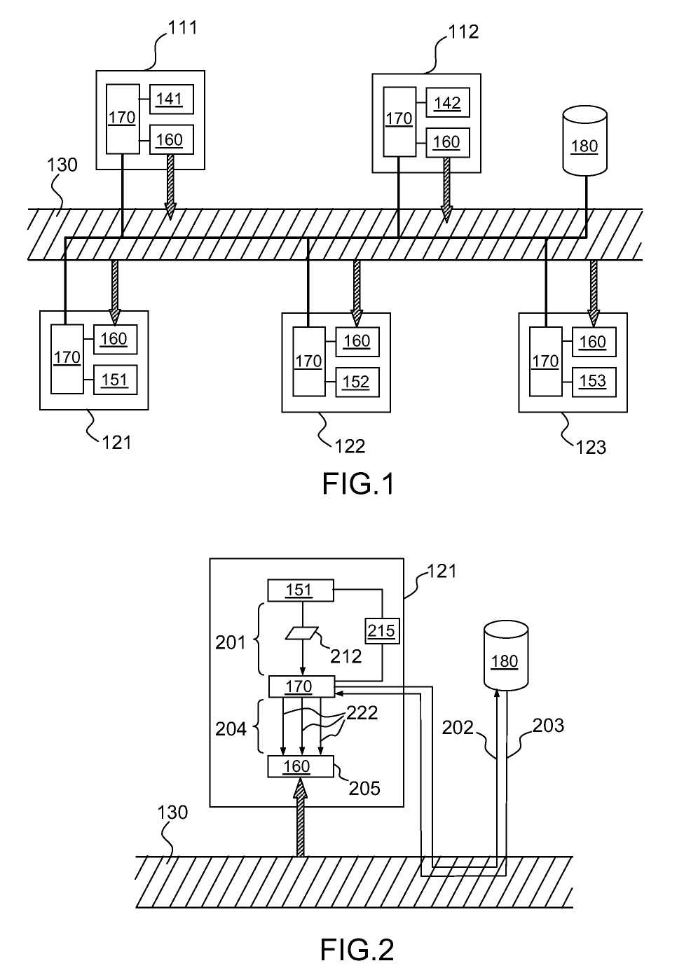

FIG. 1 shows a diagram illustrating a first embodiment of the data publication and subscription system according to the invention,

FIG. 2 shows a diagram illustrating the steps executed during the subscription to a subject in a method according to the invention,

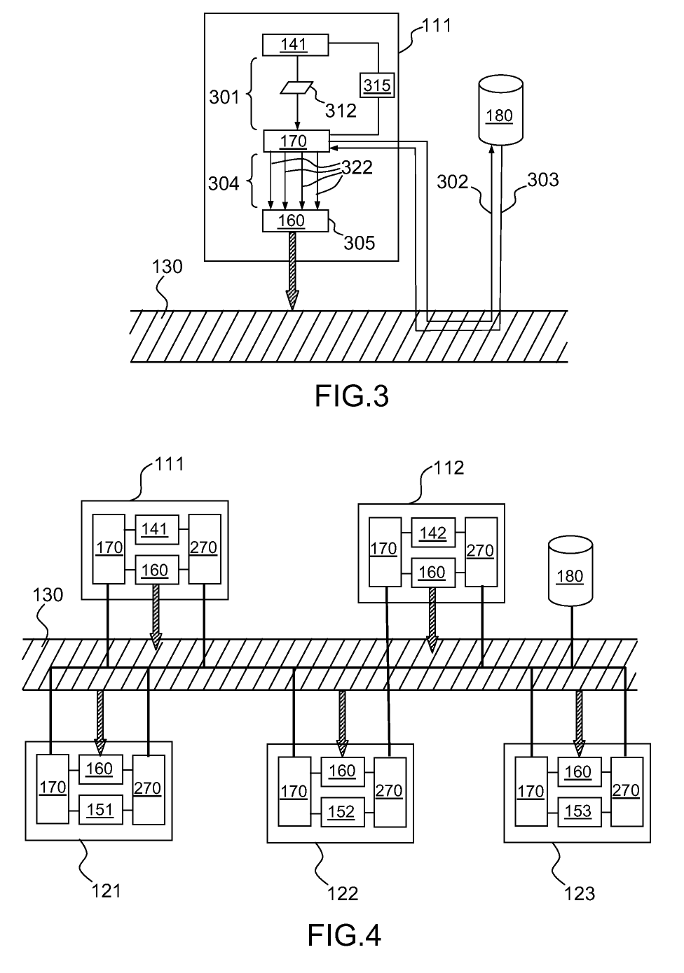

FIG. 3 shows a diagram illustrating the steps executed during the publication of a subject in a method according to the invention,

FIG. 4 shows a diagram illustrating a second embodiment of the data publication and subscription system according to the invention.

FIG. 1 illustrates, by way of a diagram, a first embodiment of the data publication/subscription system according to the invention.

Data transmitters 111, 112 and data receivers 121, 122, 123, for example computer terminals, are connected via a network 130. Each of these computer terminals 111, 112, 121, 122, 123 executes at least one application 141, 142, 151, 152, 153, each of these applications being able to differ from one another. Each application 141, 142, 151, 152, 153 communicates with a data publication and subscription infrastructure 160, said infrastructure 160 being a software module installed on each of the interconnected computer terminals 111, 112, 121, 122, 123 and enabling publication of data and subscription to data by specifying subjects of interest describing these data. An infrastructure 160 of a known type may be used, such as, for example, DDS (“Data Distribution Service”), the “Java Message Service” infrastructure specified by the Java Community Process or the WS-notification (“Web Services notification”) infrastructure standardized by the OASIS (“Organization for the Advancement of Structured Information Standards”) standardization body.

The same computer terminal may simultaneously be a data transmitter for a first set of subjects and a data receiver for a second set of subjects. For the sake of clarity, the computer terminals 111, 112, 121, 122, 123 in the example do not accumulate the data transmitter and receiver functions and each include only a single application accessing the data publication and subscription infrastructure.

Each application 141, 142, 151, 152, 153 may publish or subscribe to a certain number of subjects, the subjects handled differing from one application to another. To nevertheless enable the applications 141, 142, 151, 152, 153 to exchange data relating to a subject, a semantic module 170 is executed by each of the computer terminals 111, 112, 121, 122, 123. This semantic module 170 includes a classifier, in other words a semantic request resolution algorithm which enables such a request to be analyzed by taking into account its meaning and not only its form.

Moreover, the semantic module 170 is connected to an ontological knowledge base 180 common to the transmitter terminals and to the receiver terminals. In the example, this ontological knowledge base 180 is centralized and accessible by the computer terminals 111, 112, 121, 122, 123 via the network 130. According to a different embodiment, in which each computer terminal has sufficient resources in terms of memory and computing capacities, the knowledge base 180 is replicated on each computer terminal 111, 112, 121, 122, 123, thereby making it possible to avoid accessing the network to access the content of said knowledge base 180. The knowledge base 180 is, for example, developed by experts working in the domains involved in the applications 141, 142, 151, 152, 153, then standardized in such a way as to be able to be shared by the maximum number of applications. For each knowledge domain to be processed, it contains a data model including a set of concepts interlinked by semantic relationships, these relationships being defined, for example, via a semantic specification language such as RDF (“Resource Description Framework”) or OWL (“Web Ontology Language”). Each concept may also comprise one or more instances, i.e. elements belonging to this concept. The semantic module 170 is adapted to interrogate the knowledge base 180 to retrieve the concepts and/or instances relating to the formulated semantic request.

Moreover, association means for association between the knowledge base 180 and the subjects likely to be published or subscribed to by an application 141, 142, 151, 152, 153 are created. These association means, which enable the concepts and instances of the knowledge base 180 to be linked to the known subjects of an application 141, 142, 151, 152, 153 may assume the form, for example, of a correspondence file present in each computer terminal 111, 112, 121, 122, 123, or of a database common to all of the computer terminals and accessible by the network 130. In the example described, the association between the knowledge base 180 and the subjects likely to be subscribed to or published is carried out for each application 141, 142, 151, 152, 153 of each computer terminal 111, 112, 121, 122, 123 via an accessible file of the semantic module 170. This file contains correspondences between subjects and concepts of the knowledge base 180.

In a transmitting computer terminal 111, 112, the semantic module 170 enables publication of all of the subjects relating to a semantic request. In an analogous manner, in a receiving computer terminal 121, 122, 123, the semantic module 170 enables subscription to all of the subjects relating to a semantic request.

The steps of data transfer between a data transmitter and receiver include:
a first step during which a transmitter subscribes to a subject T;
a second step during which a receiver publishes on the subject T;
a third step during which the data associated with the subject T are routed from the transmitter to the receiver.

The publication and subscription steps in a method according to the invention are explained below in FIGS. 2 and 3.

FIG. 2 illustrates the steps executed during the subscription to a subject in a method according to the invention. These steps are described with reference to the example of the first receiver 121 of the system shown in FIG. 1.

Firstly 201, the application 151 executed by the receiver 121 formulates a semantic request 212 to the semantic module 170. This semantic request 212 may be defined by means of a suitable language, for example SPARQL (“Simple Protocol And RDF Query Language”).

Secondly 202, the semantic request 212 is interpreted by the semantic module 170 which interrogates the knowledge base 180, in contrast to a conventional request which would only be processed in respect of its form. Parameters may also be associated with the semantic request 212 to modify the behavior of the classifier, for example to control the scope of the search in the knowledge base 180.

Thirdly 203, the semantic module 170 retrieves from the knowledge base 180 the concepts and/or concept instances involved in the semantic request 212, i.e. the concepts and/or concept instances semantically compatible with the semantic request 212.

Fourthly 204, for each concept and/or instance retrieved by the processing of the semantic request 212, the subject(s) 222 associated with this concept or this instance are produced by using the association means 215—in the example, a correspondence file—between subjects handled by the application 151 and concepts of the knowledge base 180.

Fifthly 205, the infrastructure 160 subscribes to the subjects 222 produced by the semantic module 170, for example via successive calls to a conventional subscription function, available in the infrastructure 160.

FIG. 3 illustrates the steps executed during the publication of a subject in a method according to the invention. These steps are described with reference to the example of the first transmitter 111 of the system shown in FIG. 1.

Firstly 301, the application 141 executed by the transmitter 111 formulates a semantic request 312 to the semantic module 170. This request may be formulated, for example, in the same language as that in which the subscription requests are formulated in the receiving terminals 121, 122, 123.

Secondly 302, the semantic request 312 is interpreted by the semantic module 170 which interrogates the knowledge base 180.

Thirdly 303, the semantic module 170 receives the concepts and/or concept instances involved in the semantic request 312 of the knowledge base 180, i.e. the concepts and/or concept instances semantically compatible with the semantic request 312.

Fourthly 304, for each concept and/or instance retrieved by the processing of the semantic request 312, the subject(s) 322 associated with this concept or this instance are produced by using the association means 315.

Fifthly 305, the infrastructure 160 publishes the subjects 322 produced by the semantic module 170, for example via successive calls to a conventional publication function available in the infrastructure 160.

Apart from the notion of subjects which enables differentiation of the data, in some data publication and subscription systems, the content of the exchanged data is defined by a type, in other words by a formal description of the format of the exchanged data. The data type may be defined by known description languages such as OMG IDL (“Interface Description Language”), XSD (“XML Schema Description”) or by a UML (“Unified Modeling Language”) diagram.

As well as the excessive coupling caused in the prior art by the taking into account only of the syntactic aspect of the subjects, the common definition of the data types to be exchanged also causes couplings between data transmitters and receivers. A second embodiment of the system according to the invention, presented below, is intended to resolve this second aspect of the coupling problem by enabling each computer terminal present on the data publication and subscription infrastructure to manage its own data types, the infrastructure performing the translation from one type of data to another.

FIG. 4 illustrates, by way of a diagram, a second embodiment of the data publication and subscription system according to the invention. To prevent the data types from presenting an obstacle to the interoperability between applications, the knowledge base 180 is used as a pivot for the applications 141, 142, 151, 152, 153 publishing or subscribing to data via the infrastructure 160. In fact, the knowledge base 180 defines a data model common to all of these applications 141, 142, 151, 152, 153.

A translation module 270, linked to the knowledge base 180 via the network 130, is installed at least in each computer terminal 111, 112, 121, 122, 123, said translation module 270 being adapted, in a transmitting terminal 111, 112, to translate a datum expressed with the aid of the data type originating from an application 141, 142 executed by said transmitting terminal 111, 112, into a datum in the pivot data format of the knowledge base 180, and, in a receiving terminal 121, 122, 123, to translate the datum in the pivot data format into a datum expressed by means of the data type originating from an application 151, 152, 153 executed by said receiving terminal 121, 122, 123.

The translations may be carried out by the execution of scripts. In the example, two scripts can be executed by the translation module 270, the first script being used to translate a datum from one data type originating from an application into the pivot format, and the second script being used to translate a datum in the pivot format into the same datum expressed in a data type originating from an application. For example, if, for an application, the data types are described via the XSD language and the knowledge base is implemented by using the OWL or RDF/S language, the XSLT (“Extensible Stylesheet Language Transformations”) scripts can be used.

The steps necessary for translating a datum expressed in the pivot model into the same datum expressed in the data type specific to an application 141, 142, 151, 152, 153, or to translate a datum expressed in the data type specific to an application 141, 142, 151, 152, 153 into a datum expressed in the pivot model differ according to the description language of said format. By way of illustration, for a description language such as XST, IDL or a data model described by a UML (“Unified Modeling Language”) diagram, the translation of a datum is carried out in three steps during the transfer of this datum from a transmitting application 141, 142 to the infrastructure 160 or from the infrastructure 160 to a receiving application 151, 152, 153:
firstly, the translation script corresponding to the original data type (in the case of a translation into the pivot format) or to the target data type (in the case of a translation from the pivot format) is supplied, for example, by the knowledge base 180. The translation script is chosen, for example, on the basis of an annotation system specified in a data type definition document, this annotation system referencing the knowledge base 180;
secondly, the translation script previously supplied is executed on the original datum to express this datum in the target format;
thirdly, the original datum is replaced by the datum in the target format; thus, a datum is published in the pivot format and subscribed to in the format specific to the consuming application 151, 152, 153.

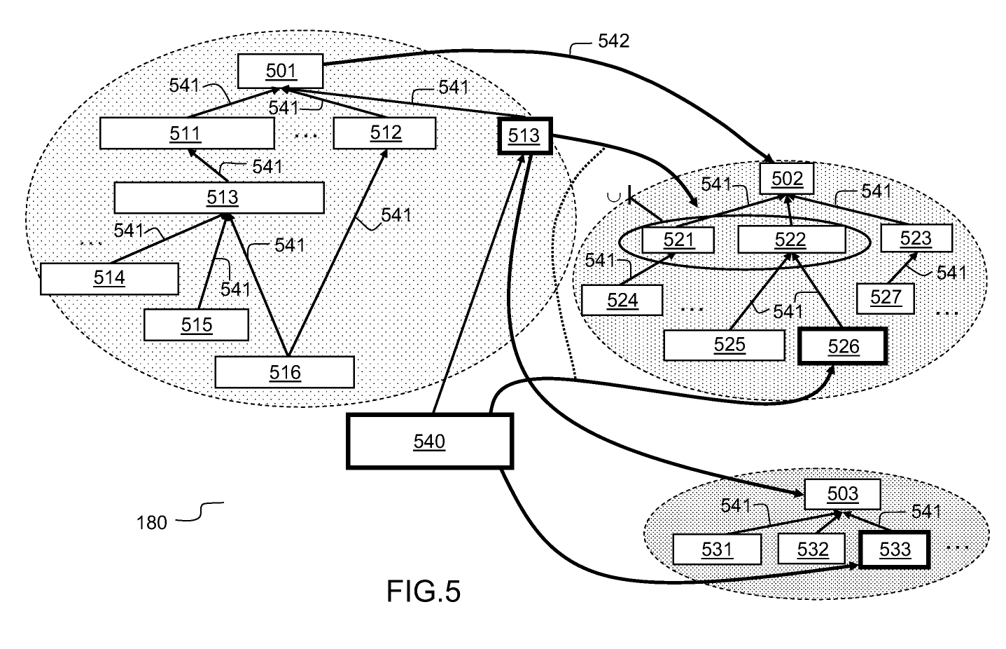

By way of illustration, FIG. 5 shows an example of an ontological knowledge base 180. In the example shown in FIG. 5, the knowledge base 180 corresponds to the military domain and includes three main concepts 501, 502, 503 corresponding respectively to the effects 501 of an attack, to human units 502, and to the terrain 503 concerned. Each of these concepts includes several linked instances or concepts.

Thus, the effects 501 are linked by the semantic relationship “is a” 541 to the information concept 511, to the destruction concept 512 and to the stop concept 513; the information 511 may then be of the type “attack on a computer network” 513, which may be an intrusion into a computer network 514, a denial of service 515 or a destruction of a computer network 516. The concept of effects 501 is also linked to the concept of human units 502 by the semantic relationship “produced by” 542. In the example, the human units 502 are military units 521, paramilitary units 522 or civil units 523; the military units may be, for example, battalions 524, the paramilitary units may take the form of a security force 525 or a guerilla unit 526, and the civil units may be “Non-Governmental Organizations” 527. Finally the terrains 503 may be divided, for example, into the following instances: mountain 531, desert 532 and urban area 533.

If a publication or subscription request, for example the request 540 “stop a guerilla unit in an urban area” is processed by the semantic module 170, the concepts compatible with this request, in this case the concepts “stop” 513, “guerrilla unit” 526 and “urban area” 533 are involved. These three concepts 513, 526, 533 are semantically linked via the semantic request 540. The publication or subscription may then be implemented on a set of subjects covering these three concepts. In a conventional publication and subscription system, such a request would not have resulted in any transmission of data between transmitters and receivers, due to its specific nature.

One advantage of the method according to the invention is that it can be implemented on existing systems without the need for substantial modifications to said system, the publication/subscription infrastructure being able to be reused and enhanced by the ontological knowledge base. The call interfaces of the infrastructure already in place can be reused, thereby facilitating the implementation of the method according to the invention.

Another advantage of the method according to the invention is that the code of the applications exchanging data via the publication and subscription system is not affected since the translation scripts are defined externally to said applications, and that these scripts are used at the time of the publication or subscription calls by the infrastructure.

1. A data subscription and publication system, comprising:
a transmitter publishing data,
a receiver subscribing to the data, the data being described by one or more identifiers, the transmitter and the receiver being connected via a network,
an ontological knowledge base common to the transmitter and the receiver, each including a semantic module connected to said base and configured to analyze a semantic request to produce identifiers semantically compatible with said request, said transmitter publishing and said receiver subscribing to the data via said identifiers.

2. The system according to claim 1, wherein the ontological knowledge base defines semantic concepts interlinked by dependency relationships, each of the identifiers likely to be published or subscribed to by a transmitter or a receiver being referenced, via association means, by at least one concept or one concept instance in said base, the semantic module including a classifier adapted to search in said base for all the identifiers semantically compatible with a semantic request.

3. The system according to claim 1, wherein the transmitter and the receiver are computer terminals, a data-consuming application or data-producing application being executed on each of said terminals, said application of each computer terminal being connected to the semantic module, which is provided with access to the ontological knowledge base via the network.

4. The system according to claim 2, wherein the transmitter and the receiver include association means for referencing the identifiers likely to be published or subscribed to by a transmitter or receiver by at least one concept or one concept instance of the knowledge base, said means including one or more correspondence files for correspondence between the concepts of said base and said identifiers.

5. The system according to claim 1, wherein the transmitter and the receiver include a translation module executing a first transformation script for transformation of a datum formatted in a language specific to said transmitter or to said receiver into a datum formatted in a pivot format specific to the knowledge base, the translation module being provided with a second transformation script for transformation of a datum formatted in a pivot format specific to the knowledge base into a datum formatted in a language specific to said transmitter or to said receiver.

6. The system according to claim 2, wherein the dependency relationships between the concepts of the ontological knowledge base are specified in the “Resource Description Framework” language or the “Web Ontology Language”.

7. A data subscription and publication method implemented in a system including at least one transmitter publishing data and one receiver subscribing to data, the data being described by one or more identifiers, said method comprising:
publishing one or more data identifiers by a transmitter, and
subscribing to one or more identifiers by a receiver, the subscribing including:
referencing, by association means, of the identifiers likely to be subscribed to by said receiver to a semantic specification;
a semantic module included in said data receiver receiving a semantic request;
the semantic module interrogating an ontological knowledge base common to the receivers and transmitters of said system to find semantic concepts semantically compatible with said request;
the semantic module translating said concepts into identifiers by using association means, and
executing a subscription request for each of said identifiers supplied by the semantic module.

8. The method according to claim 7, wherein the publishing includes:
referencing, by association means, of the identifiers likely to be published by said receiver to a semantic specification;
a semantic module included in said data receiver receiving a semantic request;
the semantic module interrogating an ontological knowledge base common to the receivers and transmitters of said system to find semantic concepts semantically compatible with said request;
the semantic module translating said concepts into identifiers by using association means,
executing a publication request for each of said identifiers supplied by the semantic module.

9. The method according to claim 7, wherein the semantic requests are formulated in the “Simple Protocol And RDF Query Language”.
